(19) United States
(12) Patent Application Publication
(10) Pub. No.: US 2026/0330828 A1
(43) Pub. Date: Oct. 22, 2026

(54) MIXED SUPERVISION FOR SPECTRAL RECONSTRUCTION

(71) Applicant: SAMSUNG ELECTRONICS CO., LTD., Suwon-si (KR)

(72) Inventors: Shira WERMAN, Tel-Aviv (IL); Evgeny SOLOVEICHIK, Netanya (IL); Genady PAIKIN, Netanya (IL); Roy SHAUL, Tel-Aviv (IL); Roy JENNINGS, Tel-Aviv (IL)

(73) Assignee: SAMSUNG ELECTRONICS CO., LTD., Suwon-si (KR)

(21) Appl. No.: 19/640,792

(22) Filed: Apr. 7, 2026

Related U.S. Application Data
(60) Provisional application No. 63/789,839, filed on Apr. 16, 2025.

(51) Int. Cl. G06V 20/10; G06N 3/09; G06T 7/90; G06V 10/60

(52) U.S. Cl. CPC G06V 20/194; G06N 3/09; G06T 7/90; G06V 10/60; G06T 2207/10024; G06T 2207/10036

(57) ABSTRACT

An electronic device for training a spectral reconstruction model, including: at least one processor; and memory storing one or more instructions which cause the electronic device to: obtain a first red-green-blue (RGB) image of a scene including an object corresponding to a predetermined reflectance value, obtain a first illumination value corresponding to the first RGB image, provide the first RGB image and the first illumination value as input to the spectral reconstruction model to obtain a first hyperspectral image, obtain a first patch corresponding to the object from the first hyperspectral image, calculate a supervised loss based on a comparison between a first spectral value corresponding to the first patch and a ground truth spectral value determined based on the predetermined reflectance value and the first illumination, and train the spectral reconstruction model based on the supervised loss to obtain a trained spectral reconstruction model.

### CROSS-REFERENCE TO RELATED APPLICATION

This application is based on and claims priority under 35 U.S.C. § 119 to U.S. Provisional Patent Application No. 63/789,839, filed on Apr. 16, 2025, in the U.S. Patent & Trademark Office, the disclosure of which is incorporated by reference herein in its entirety.

### BACKGROUND

### 1. Field

The present disclosure relates to image processing, and more particularly to performing spectral reconstruction using artificial intelligence models, training the artificial intelligence models to perform the spectral reconstruction, and generating training datasets for performing the training.

### 2. Description of Related Art

Hyperspectral images may provide spatial and spectral representations of scenes which may include objects that are illuminated by sources of illumination. Unlike red-green-blue (RGB) images, which may divide the light spectrum into three image slices corresponding to a red color channel, a green color channel, and a blue color channel, hyperspectral images may divide the light spectrum into a large number of image slices which may be separated by a predetermined spectral interval. A hyperspectral image may be represented as a cube in which image slices corresponding to two spatial dimensions (e.g., pixels) are stacked along one spectral dimension (e.g., wavelength). For example, at each sampled wavelength in the spectral dimension, the cube may include an image slice that represents the reflectance of the scene at the corresponding wavelength.

Spectral reconstruction may refer to a process for generating a hyperspectral image based on an input RGB image by performing a pixel-to-pixel mapping that maps each pixel value in the RGB image from the RGB domain to the HS domain. Some approaches to spectral reconstruction may involve artificial intelligence models that are trained using RGB data that is synthesized from hyperspectral images. This may ensure perfect pixel-to-pixel alignment between image pairs included in the training data. However, the synthetic data may not generalize well to RGB image data that is captured using real RGB cameras. In addition, acquiring HS data may be a cumbersome process, which limit the available training datasets.

### SUMMARY

Provided are systems, methods, and devices for reconstructing hyperspectral images from red-green-blue (RGB) images, training models (e.g., artificial intelligence models) for performing the reconstruction, and collecting or generating training datasets which may be used to perform the training.

Additional aspects will be set forth in part in the description which follows and, in part, will be apparent from the description, or may be learned by practice of the presented embodiments.

In accordance with an aspect of the disclosure, an electronic device for training a spectral reconstruction model, includes: a red-green-blue (RGB) camera configured to capture RGB images; a spectral photometer configured to measure illuminations to obtain illumination values;
at least one processor; and memory storing one or more instructions which, when executed by the at least one processor, cause the electronic device to: obtain, using the RGB camera, a first red-green-blue (RGB) image of a scene comprising an object, wherein the object corresponds to a predetermined reflectance value, obtain a first illumination value corresponding to the first RGB image by measuring, using the spectral photometer, a first illumination of the scene when the first RGB image is captured, provide the first RGB image and the first illumination value as input to the spectral reconstruction model to obtain a first hyperspectral image, obtain a first patch corresponding to the object from the first hyperspectral image, calculate a supervised loss based on a comparison between a first spectral value corresponding to the first patch and a ground truth spectral value determined based on the predetermined reflectance value and the first illumination, and train the spectral reconstruction model by modifying at least one parameter of the spectral reconstruction model based on the supervised loss to obtain a trained spectral reconstruction model.

In accordance with an aspect of the disclosure, a method for training a spectral reconstruction model, includes: obtaining a first red-green-blue (RGB) image of a scene comprising an object, wherein the object corresponds to a predetermined reflectance value; obtaining a first illumination value corresponding to the first RGB image, wherein the first illumination value represents a first illumination of the scene when the first RGB image is captured; providing the first RGB image and the first illumination value as input to the spectral reconstruction model to obtain a first hyperspectral image; obtaining a first patch corresponding to the object from the first hyperspectral image; calculating a supervised loss based on a comparison between a first spectral value corresponding to the first patch and a ground truth spectral value determined based on the predetermined reflectance value and the first illumination; and training the spectral reconstruction model by modifying at least one parameter of the spectral reconstruction model based on the supervised loss to obtain a trained spectral reconstruction model.

In accordance with an aspect of the disclosure, an electronic device for training a spectral reconstruction model includes: at least one processor; and memory storing one or more instructions which, when executed by the at least one processor, cause the electronic device to: obtain a first image corresponding to a first spectral space, wherein the first image comprises a first patch associated with a predetermined reflectance value, obtain a first illumination value corresponding to the first image, determine a ground truth spectral value based on the predetermined reflectance value and the first illumination value, provide the first image and the first illumination value as input to the spectral reconstruction model to obtain a second image corresponding to second spectral space, wherein a dimension of the second spectral space is higher than a dimension of the first spectral space, and wherein the second image comprises a second patch corresponding to the first patch, calculate a supervised loss based on a comparison between the ground truth spectral value and a spectral value corresponding to the second patch, and train the spectral reconstruction model by modifying at least one parameter of the spectral reconstruction model based on the supervised loss to obtain a trained spectral reconstruction model.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of a system for performing image processing, according to embodiments;

FIG. 2 is a block diagram of a training module for training a spectral reconstruction model, according to embodiments;

FIG. 3 is a diagram showing an example of red-green-blue (RGB) images that may be included in a training dataset for training a spectral reconstruction model, according to embodiments;

FIGS. 4, 5, and 6 are block diagrams illustrating examples of a training process for training a spectral reconstruction model; and

FIGS. 7A, 7B, and 7C are flowcharts of an example process for training a spectral reconstruction model, according to embodiments.

### DETAILED DESCRIPTION

Embodiments may relate to techniques for reconstructing hyperspectral images from red-green-blue (RGB) images, techniques for training models (e.g., artificial intelligence models) for performing the reconstruction, and techniques for collecting or generating training datasets which may be used to perform the training.

As discussed above, some approaches to spectral reconstruction may involve artificial intelligence models that are trained using synthetic RGB data that is synthesized from hyperspectral images. However, the synthetic RGB data may not generalize well to RGB image data that is captured using real RGB cameras. In addition, acquiring HS data for training datasets may be a difficult process which requires the use of expensive and complicated equipment.

To address these challenges and others, embodiments of the present disclosure may relate to techniques for generating and using training datasets which include RGB images of scenes including objects (e.g., color charts) which correspond to known or predetermined spectral reflectance values. As a result, embodiments may simplify a training process for training spectral reconstruction models, while reducing or eliminating the reliance on full hyperspectral datasets.

Embodiments may leverage a training dataset which includes RGB images of scenes including objects (e.g., color charts) that correspond to known or predetermined reflectance values, as well as illumination values obtained by measuring illuminations of the scenes. In the areas or regions of the RGB images which include the objects (e.g., the color charts) corresponding to the known reflectance values, a ground truth hyperspectral value may be derived based on the known reflectance values and the illumination values. Accordingly, embodiments may provide a more accessible alternative to full hyperspectral datasets while reducing the domain gap between training and application. Embodiments may further relate to a mixed-supervision training process which combines supervised training for regions corresponding to known spectra, and self-supervised training across the entire image, while also evaluating the fidelity of the spectral reconstruction process.

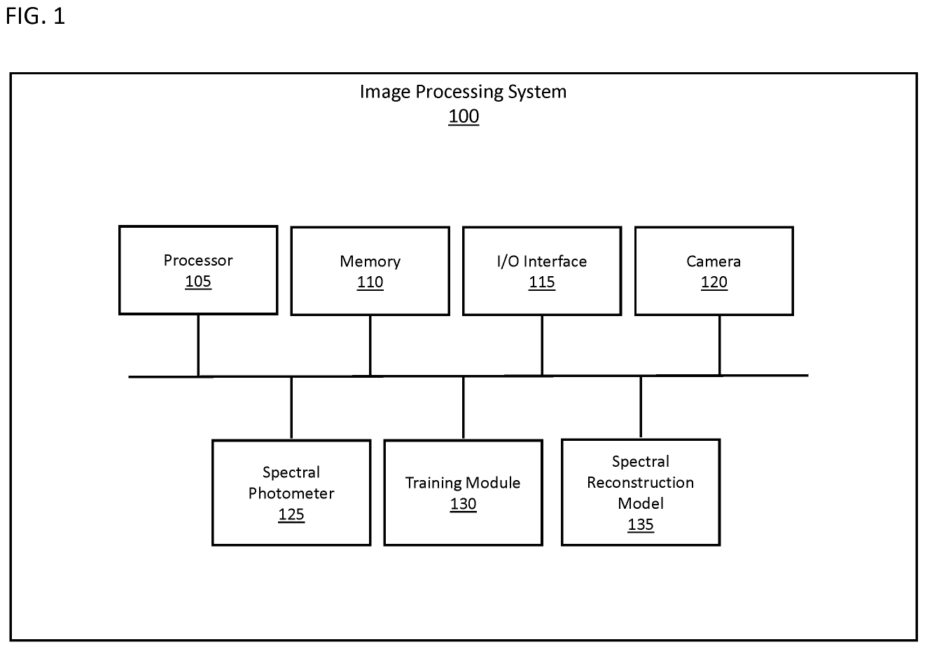

FIG. 1 is a block diagram of a system for performing image processing, according to embodiments. As shown in FIG. 1, the image processing system 100 may include a processor 105, a memory 110, an input/output (I/O) interface 115, a camera 120, a spectral photometer 125, a training module 130, and a spectral reconstruction model 135.

The processor 105 may be, or may include, an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In embodiments, the processor 105 may configured to operate a memory array using a memory controller. For example, a memory controller may be integrated into the processor 105. In embodiments, the processor 105 may be configured to execute computer-readable instructions stored in a memory to perform various functions. However, embodiments are not limited thereto, and the memory controller may be included in any other element of the image processing system 100, for example in the memory 110.

The memory 110 (e.g., a memory device) may include at least one of a random access memory (RAM), a read-only memory (ROM), and a hard disk. For example, the memory 110 may include solid state memory and a hard disk drive. The memory 110 may be used to store computer-readable and computer-executable software including instructions which, when executed, may cause the processor 105 to perform various functions described herein. For example, the memory 110 may include, among other things, a basic input/output system (BIOS) which may control basic hardware or software operation such as the interaction with peripheral components or devices. In embodiments, the memory controller may operate memory cells. For example, the memory controller may include a row decoder, column decoder, or both. In some cases, memory cells within a memory 110 store information in as a logical state of the memory cells.

The I/O interface 115 may manage signals which are input from and output to the image processing system 100 and the elements included therein. The I/O interface 115 may also manage peripherals which not integrated into a device. For example, the I/O interface 115 may represent a physical connection or port to an external peripheral. In embodiments, the I/O interface 115 may utilize an operating system such as iOS®, ANDROID®, MS-DOS®, MS-WINDOWS®, OS/2®, UNIX®, LINUX®, or another operating system. In embodiments, the I/O interface 115 may represent or interact with a modem, a keyboard, a mouse, a display, a touchscreen, or a similar device. In embodiments, the I/O interface 115 may be implemented as part of a processor 105. In embodiments, a user may interact with a device using the I/O interface 115 or using hardware components controlled by the I/O interface 115.

The image processing system 100 may include an optical instrument (e.g., the camera 120, an image sensor, etc.) for recording or capturing images, which may be stored locally, transmitted to another location, etc. For example, the camera 120 may capture visual information using one or more photosensitive elements that may be tuned for sensitivity to a visible spectrum of electromagnetic radiation. A resolution of the visual information may be measured in pixels, where each pixel may relate an independent piece of captured information. In embodiments, each pixel may correspond to one component of, for example, a two-dimensional (2D) Fourier transform of an image. Computation methods may use pixel information to reconstruct images captured by the device. In the camera 120, one or more image sensors may convert light incident on a lens of the camera 120 into an analog or digital signal. The image processing system 100 may then display an image on a display panel based on the digital signal. According to embodiments, the camera 120 may be, or may include, an RGB camera which may be used to capture RGB images of scenes, but embodiments are not limited thereto.

A pixel (e.g., a pixel sensor) may store information about received electromagnetic radiation (e.g., light). Each pixel may include one or more photodiodes and one or more complementary metal oxide semiconductor (CMOS) transistors. A photodiode may receive a light and may output charges. The amount of output charges may be proportional to the amount of light received by the photodiode. CMOS transistors may output a voltage based on charges output from the photodiode. A level of a voltage output from the photodiode may be proportional to the amount of charges output from the photodiode. For example, the level of the voltage output from a photodiode may be proportional to the amount of light received by the photodiode.

The spectral photometer 125 may be configured to measure an illumination of a scene, and may generate illumination values which indicate the measured illumination. For example, the camera 120 may capture an image (e.g., an RGB image) of a scene, and the spectral photometer 125 may measure an illumination of the scene to generate an illuminance value. According to embodiments, the measured illumination may be the same as, or similar to, the illumination of the scene when the RGB image was captured, and the illuminance value may therefore correspond to the RGB image.

The spectral reconstruction model 135 may be used to perform spectral reconstruction on input images to obtain output hyperspectral images. For example, the spectral reconstruction model 135 may receive an input image corresponding to a first spectral space (e.g., an RGB spectral space), and may map a pixel value corresponding to each pixel in the input image to another pixel value corresponding to a second spectral space (e.g., a hyperspectral spectral space) to generate an output image corresponding to the second spectral space. As one example, the input image may be an RGB image including a red color channel, a green color channel, and a blue color channel, and the output image may be a hyperspectral image including a plurality of color channels that are different from the red color channel, the green color channel, and the blue color channel. For example, the output hyperspectral image may include thirty-one color channels which may be separated by a predetermined interval, but embodiments are not limited thereto. In embodiments, the input images may be images which are obtained or captured using the camera 120, or may be images which are received through the I/O interface 115, for example from another device. In embodiments, the output images may be displayed using a display or touchscreen included in the I/O interface 115, but embodiments are not limited thereto. For example, in some embodiments, the output images may be used by the processor 105 or another component of the image processing system 100 to perform computer vision (CV) tasks, or may be transmitted to another device using the I/O interface 115.

The training module 130 may be configured to train machine learning, artificial intelligence, and/or neural network models or architectures included in the image processing system 100, for example at least one neural network model included in the spectral reconstruction model 135. In embodiments, the image processing system 100 may implement image processing networks to perform specialized tasks. For example, at least one of machine learning, artificial intelligence, and neural network processing may be implanted for various imaging and computer vision applications. A neural network may refer to a type of computer algorithm that is capable of learning specific patterns without being explicitly programmed, but through iterations over known data. A neural network may refer to a cognitive model that includes input nodes, hidden nodes, and output nodes. Nodes in the network may have an activation function that computes whether the node is activated based on the output of previous nodes. Training the system may involve supplying values for the inputs, and modifying edge weights and activation functions (algorithmically or randomly) until the result closely approximates a set of desired outputs.

An artificial neural network may refer to a hardware or a software component that includes a number of connected nodes (e.g., artificial neurons), which may loosely correspond to the neurons in a human brain. Each connection, or edge, may transmit a signal from one node to another (similar to the physical synapses in a brain). When a node receives a signal, the node may process the signal and then transmit the processed signal to other connected nodes. In embodiments, the signals between nodes may include real numbers, and the output of each node may be computed by a function of the sum of its inputs. In embodiments, the nodes may determine their outputs using other mathematical algorithms (e.g., selecting the max from the inputs as the output) or any other suitable algorithm for activating the node. Each node and edge may be associated with one or more node weights which may be used to determine how the signal is processed and transmitted.

During a training process, these weights may be adjusted, for example by the training module 130, to improve the accuracy of the result (e.g., by minimizing a loss function which corresponds in some way to the difference between the current result and the target result). The weight of an edge increases or decreases the strength of the signal transmitted between nodes. In embodiments, nodes may have a threshold below which a signal is not transmitted at all. In some embodiments, the nodes may be aggregated into layers, and different layers may perform different transformations on their inputs. The initial layer may be referred to as the input layer, and the last layer is known as the output layer. In some embodiments, signals may traverse certain layers multiple times. In embodiments, at least one of the weights and thresholds may be referred to as model parameters.

A convolutional neural network (CNN) may refer to a class of neural networks that may be used in computer vision or image classification systems. In embodiments, a CNN may enable processing of digital images with minimal pre-processing. A CNN may be characterized by the use of convolutional (or cross-correlational) hidden layers. These layers may apply a convolution operation to the input before signaling the result to the next layer. Each convolutional node may process data for a limited field of input, which may be referred to as the receptive field. During a forward pass of the CNN, filters at each layer may be convolved across the input volume, computing the dot product between the filter and the input. During the training process, the filters may be modified so that they activate when they detect a particular feature within the input. In embodiments, at least one machine learning model, artificial intelligence model, or neural network model included in the spectral reconstruction model 135 may be, or may include, one or more image processing networks, for example one or more artificial neural networks, CNNs, etc., which may be trained using the training module 130. However, embodiments are not limited thereto. For example, in some embodiments, the spectral reconstruction model 135 may include at least one of a Generative Adversarial Network (GAN), a U-Net model, an autoencoder (AE) model, and a transformer model instead of, or in addition to, a CNN model, some or all of which may be trained using the training module 130.

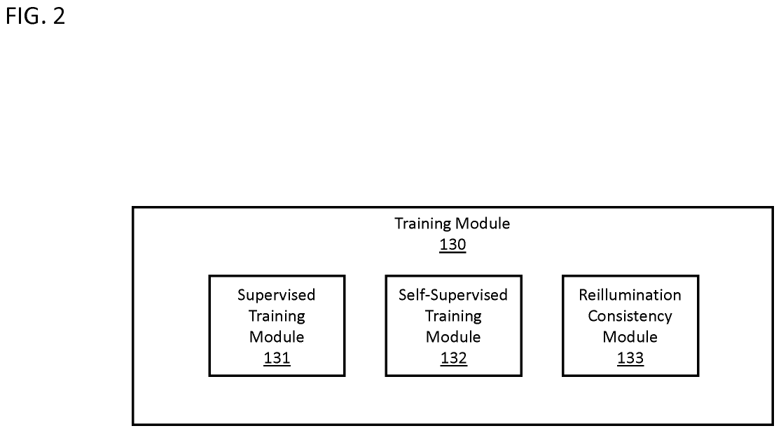

In embodiments, the training module 130 may be used to train at least one machine-learning, artificial intelligence, or neural network model included in the image processing system 100, for example the spectral reconstruction model 135. According to embodiments, the spectral reconstruction model 135 may be trained using at least one from among three training processes, for example a supervised training process based on sparse supervised training data, a self-supervised RGB consistency training process, and a reillumination consistency training process. According to embodiments, these training processes may be performed using the training module 130. For example, as shown in FIG. 2, the training module 130 may include a supervised training module 131 configured to perform the supervised training process, a self-supervised training module 132 configured to perform the self-supervised RGB consistency training process, and a reillumination consistency module 133 configured to perform the reillumination consistency training process.

According to embodiments, an RGB image Icaptured by an RGB camera (e.g., the camera 120) may be described mathematically using a common single illumination image formation model according to Equation 1 below.

Ik=∫_{Λ}R(x,y;λ)L(λ)fₖ(λ)dλ,k∈{R,G,B} (Equation 1)

In Equation 1 above, (x, y) may denote spatial coordinates of a particular pixel, and k may denote a channel (R, G or B) in the RGB image I. In addition, R may denote a reflectance value of the scene, and L may denote an illuminant (e.g., an illumination) of the scene. A system response function for the k^{th} channel may be denoted as ƒₖ(λ), where the parameter λ may correspond to an observed wavelength of light, and an integration domain Λ may encompass wavelengths for which the RGB camera may exhibit a non-negligible response.

According to embodiments, the spectral reconstruction model 135 may be used to recover a discrete spectral value S for each pixel (x, y). The spectral values S may be discrete, and may correspond to a plurality of sampled wavelengths between a minimum wavelength λₘᵢₙ-λₘₐₓ. In some embodiments, the sampled wavelengths may be spaced at regular intervals separated by a gap G, which may be expressed in units of nanometers (nm), but embodiments are not limited thereto. According to embodiments, after discretization of the wavelength domain, the spectral value S may be expressed according to Equation 2 below.

$$S ( x , y ; λ ) = R ( x , y ; λ ) L ( λ ) , \qquad ( Equation 2 )$$

$$λ = {λ}_{min} + Gj ,$$

$$j ∈ \{ 0 , 1 , 2 , … , \frac{{λ}_{max} - {λ}_{min}}{G} \}$$

In some embodiments, a hyperspectral image generated by the spectral reconstruction model 135 may include, for example, thirty-one image slices corresponding to thirty-one discrete wavelengths (and therefore thirty-one color channels), but embodiments are not limited thereto.

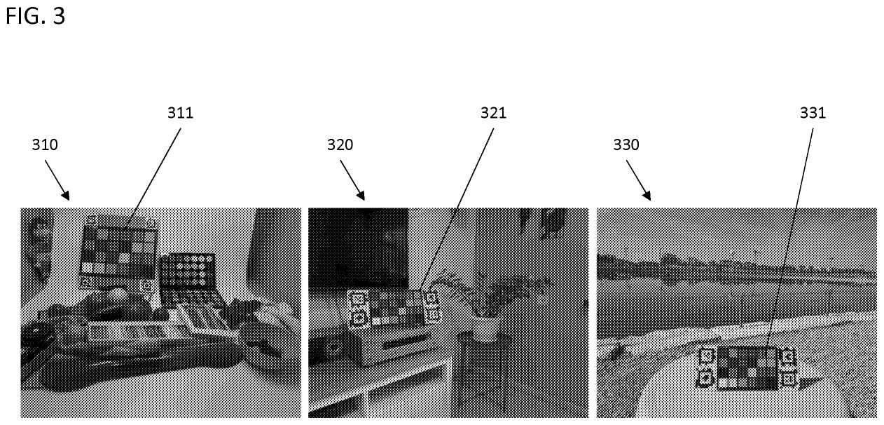

As discussed above, the spectral reconstruction model 135 may be trained using a training dataset that includes a plurality of RGB images of scenes including objects (e.g., color charts) which correspond to known or predetermined reflectance values, and also includes a plurality of illumination values corresponding to the plurality of RGB images. As shown in FIG. 3, the training dataset may include at least one of an image 310 of a scene including an object 311, an image 320 of a scene including an object 321, and an image 330 of a scene including an object 331. According to embodiments, the RGB images may be captured using the camera 120 and the illumination values may be obtained using the spectral photometer 125, but embodiments are not limited thereto. Although examples are described herein in which the object is a color chart, embodiments are not limited thereto. For example, in some embodiments, any object corresponding to a known or predetermined reflectance value may be used. Although examples are described herein which relate to RGB images, embodiments are not limited thereto. For example, in some embodiments, the images may correspond to any spectral space, as desired.

According to embodiments, the spectral reconstruction model 135 may be trained based on ground truth spectral values that may be obtained using the known or predetermined reflectance values and the illumination values described above. For example, a ground truth spectral value for an image patch corresponding to an object (e.g., a color chart) corresponding to the known or predetermined reflectance value may be obtained by multiplying the known or predetermined reflectance value with the illumination value, but embodiments are not limited thereto.

As shown in FIG. 3, the image 310 may include one or more additional objects other than the object 311, the image 320 may include one or more additional objects other than the object 321, and the image 330 may include one or more additional objects other than the object 331. According to embodiments, the reflectance values of these additional objects may be unknown. Therefore, the training dataset may not include ground truth spectral values corresponding to image patches including these additional objects. As a result, the training dataset may be referred to as a sparse training dataset.

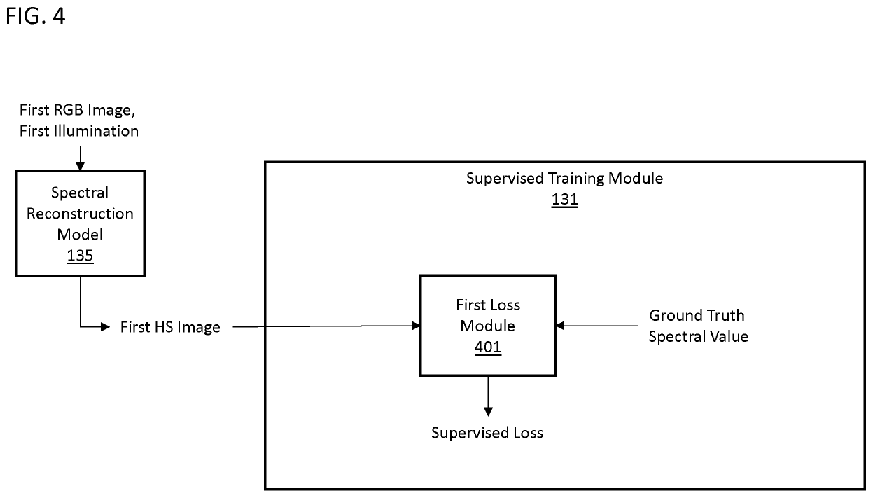

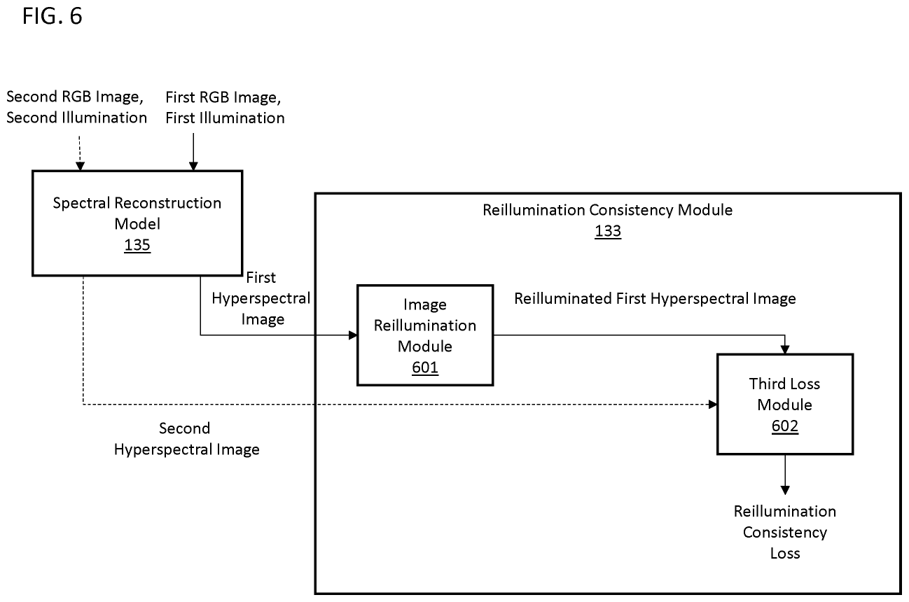

FIGS. 4, 5, and 6 are a block diagrams illustrating examples of a training process for training a spectral reconstruction model. As discussed above, the spectral reconstruction model 135 may be trained using at least one from among three training processes, for example a supervised training process based on sparse supervised training data (e.g., the training dataset discussed above with reference to FIG. 3), a self-supervised RGB consistency training process, and a reillumination consistency training process.

For example, the spectral reconstruction model 135 may receive a first input including a first RGB image I and a first illuminance value from the training dataset, and may generate a first hyperspectral image Y based on the first input. According to embodiments, the spectral reconstruction model 135 may be trained based on at least one of three loss values which may be calculated based on the first hyperspectral image generated by the spectral reconstruction model 135.

For example, as shown in FIG. 4, a supervised training process may be performed by the supervised training module 131 based on a supervised loss [symbol] ₛᵤₚ. For example, the supervised training module 131 may include a first loss module 401 which may calculate the supervised loss [symbol] ₛᵤₚ based on a comparison between a ground truth spectral value corresponding to an object included in the first RGB image I, and a first spectral value corresponding to pixels included in a first patch corresponding to the object in the first hyperspectral image Y. According to embodiments, the supervised loss [symbol] ₛᵤₚ may be calculated using any type of loss function, as desired. In some embodiments, the supervised loss [symbol] ₛᵤₚ may be obtained by averaging a loss calculated over some or all pixels included in some or all patches for which ground truth spectral values are available in some or all of the images included in the training dataset. According to embodiments, the training module 130 may then train the spectral reconstruction model 135, for example by modifying at least one parameter of the spectral reconstruction model 135 based on the supervised loss [symbol] ₛᵤₚ, to obtain a trained spectral reconstruction model 135.

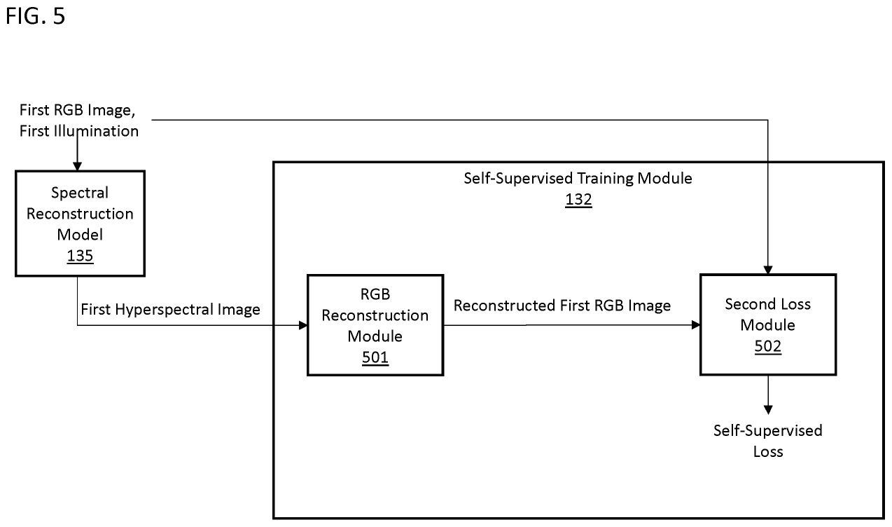

However, because the ground truth spectral values may only be available for some portions of the first hyperspectral image Y (e.g., portions corresponding to the object having the known or predetermined reflectance value), it may be difficult for the spectral reconstruction model 135 to generalize to the entire image based only on the supervised training process. Therefore, in some embodiments, as shown in FIG. 5, a self-supervised training process may be performed by the self-supervised training module 132. For example, the self-supervised training module 132 may include an RGB reconstruction module 501, which may be used to generate a reconstructed RGB image by down-sampling the first hyperspectral image Y back into the RGB spectral space using a filter response function ƒ corresponding to the RGB camera (e.g., the camera 120) used to capture the RGB image I. The self-supervised training module 132 may also include a second loss module 502, which may calculate a self-supervised loss [symbol] _{self} by comparing the reconstructed RGB image to the image to the original RGB image. According to embodiments, the self-supervised loss [symbol] _{self} may help to ensure that the reconstructed RGB image is physically plausible, by ensuring the recovered spectra accurately reproduces the RGB values included in the RGB image Iwhen the first hyperspectral image Y is down-sampled using the filter response function ƒ. In some embodiments, the self-supervised loss [symbol] _{self} may be calculated according to Equation 3 below:

[symbol]

_{self}(Y)=ƒₗₒₛₛ(I,ƒ·Y) (Equation 3)

In embodiments, ƒₗₒₛₛ may denote any type of loss function, as desired, and may be the same as, or different than, the loss function discussed above with reference to the supervised loss [symbol] ₛᵤₚ. In embodiments, ƒ·Y may denote the reconstructed RGB image. In embodiments, the self-supervised loss [symbol] _{self} may also be referred to as an RGB consistency loss. According to embodiments, the training module 130 may then train the spectral reconstruction model 135, for example by modifying at least one parameter of the spectral reconstruction model 135 based on the self-supervised loss [symbol] _{self}, to obtain the trained spectral reconstruction model 135.

In some embodiments, to add a per-pixel regularization in the hyperspectral domain, a reillumination consistency training process may be performed by the reillumination consistency module 133. For example, For example, the reillumination consistency training process may be performed when the training dataset includes multiple different RGB images of a single scene captured under multiple different illuminations. For example, when the training dataset includes a first RGB image I₁ corresponding to a first illumination value L₁ and a second RGB image I₂ corresponding to a second illumination value L₂ of the same scene, the reflectance values R_{scene} should be identical, even though the illumination values differ. Therefore, a first spectral value S₁ corresponding to the first illumination L₁ should be equal to a second spectral value S₂ corresponding to the second illumination L₂. According to Equation 2 above, it may be determined that S₁=R_{scene}L₁ and S₂=R_{scene} L₂, and it may be further determined that

$${S}_{2} = \frac{{S}_{1} {L}_{2}}{{L}_{1}} ,$$

which may be used to calculate the reillumination consistency loss [symbol] ᵣₑᵢₗₗᵤₘᵢₙₐₜᵢₒₙ in the hyperspectral domain.

For example, the spectral reconstruction model 135 may generate a first hyperspectral image Y₁ based on the first RGB image I₁ and the first illumination value L₁, and a second hyperspectral image Y₂ based on the second RGB image I₂ and the second illumination value L₂. According to embodiments, the reillumination consistency module 133 may include an image reillumination module 601 which may receive the first hyperspectral image Y₁, and may divide by the first illumination value L₁ and multiply by the second illumination value L₂ to generate a reilluminated first hyperspectral image. According to embodiments, the reilluminated first hyperspectral image may be expressed as

$$\frac{{Y}_{1} {L}_{2}}{{L}_{1}} .$$

As a result, the reillumination consistency loss [symbol] ᵣₑᵢₗₗᵤₘᵢₙₐₜᵢₒₙ may be calculated according to Equation 4 below:

$${ℒ}_{reillumination} ( {Y}_{1} , {Y}_{2} ) = {f}_{loss} ( \frac{{Y}_{1} {L}_{2}}{{L}_{1}} , {Y}_{2} ) \qquad ( Equation 4 )$$

In embodiments, ƒₗₒₛₛ may denote any type of loss function, as desired, and may be the same as, or different than, the loss function discussed above with reference to Equation 3. According to embodiments, the training module 130 may then train the spectral reconstruction model 135, for example by modifying at least one parameter of the spectral reconstruction model 135 based on the reillumination consistency loss [symbol] ᵣₑᵢₗₗᵤₘᵢₙₐₜᵢₒₙ, to obtain the trained spectral reconstruction model 135.

According to embodiments, the trained spectral reconstruction model 135 may be trained based on an overall loss function Lₜₒₜₐₗ, which may be expressed as a weighted combination of the losses discussed above according to Equation 5 below.

Lₜₒₜₐₗ=α [symbol] ₛᵤₚ+B [symbol] _{self}+γ [symbol] ᵣₑᵢₗₗᵤₘᵢₙₐₜᵢₒₙ (Equation 5)

In Equation 5, a, B, and y may denote weighting coefficients, and may be set as desired.

According to embodiments, each training epoch or iteration of the training process used to train the spectral reconstruction model 135 may be performed based on one or more of the supervised loss [symbol] ₛᵤₚ, the self-supervised loss [symbol] _{self}, and the reillumination consistency loss [symbol] ᵣₑᵢₗₗᵤₘᵢₙₐₜᵢₒₙ. For example, in some embodiments, the supervised loss £ sup and the self-supervised loss [symbol] _{self} may be calculated for every image at every iteration of the training process, and the reillumination consistency loss [symbol] ᵣₑᵢₗₗᵤₘᵢₙₐₜᵢₒₙ may be calculated only for some selected image pairs at each iteration, but embodiments are not limited thereto. In some embodiments, only the supervised loss [symbol] ₛᵤₚ may be calculated, while the self-supervised loss [symbol] _{self} and the reillumination consistency loss [symbol] ᵣₑᵢₗₗᵤₘᵢₙₐₜᵢₒₙ may not be calculated. Accordingly, the self-supervised loss [symbol] _{self} and the reillumination consistency loss [symbol] ᵣₑᵢₗₗᵤₘᵢₙₐₜᵢₒₙ may be referred to as auxiliary losses. However, this is only an example, and embodiments are not limited thereto.

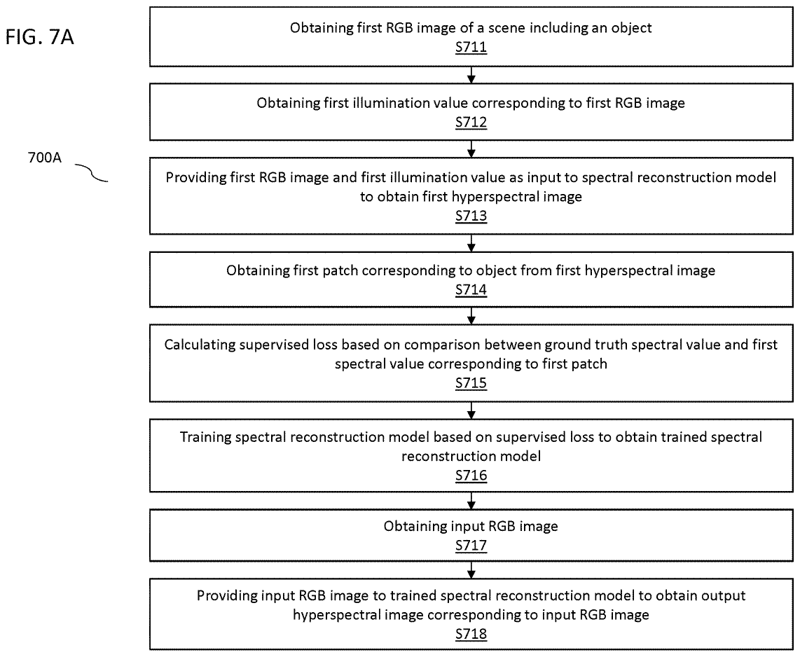

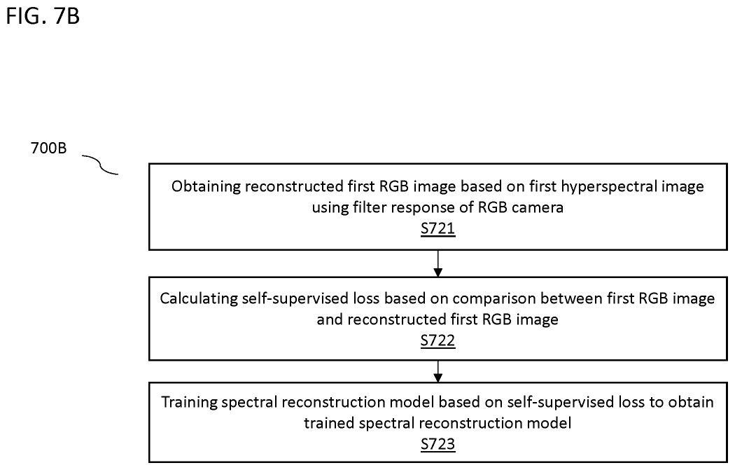

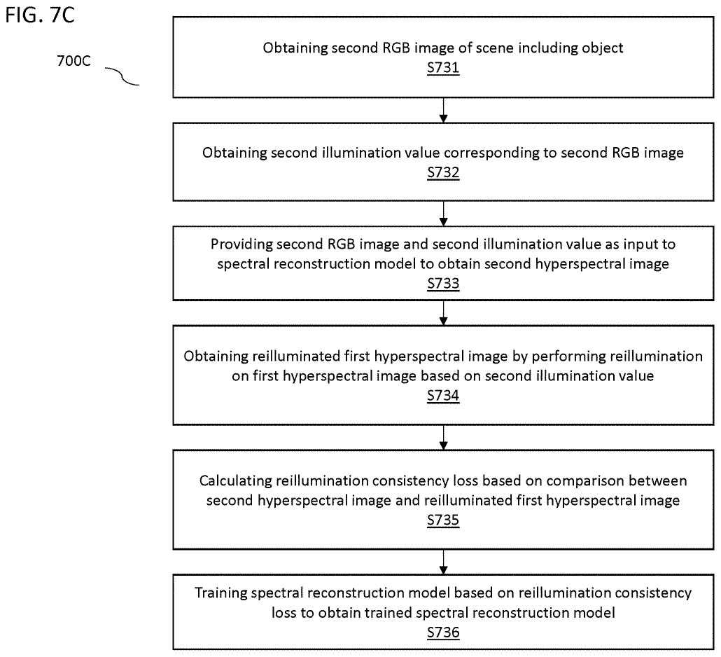

FIG. 7A is a flowchart of an example process for training a spectral reconstruction model, according to embodiments. In some implementations, one or more process blocks of FIG. 7A may be performed by any of the elements discussed above, for example one or more of the image processing system 100, the camera 120, the spectral photometer 125, the training module 130, the spectral reconstruction model 135, and any of the components included therein.

As shown in FIG. 7A, at operation S711 the process 700A may include obtaining a RGB image of a scene including an object. In embodiments, the object may correspond to a predetermined reflectance value. In embodiments, the first RGB image may correspond to one or more of the images 310, 320, and 330 discussed above, and the object may correspond to one or more of the objects 311, 321, and 331 discussed above. In embodiments, the first RGB image may correspond to the RGB image I discussed above.

As further shown in FIG. 7A, at operation S712 the process 700A may include obtaining a first illumination value corresponding to the first RGB image. In embodiments, the first illumination value may represent a first illumination of the scene when the first RGB image is captured. In embodiments, the first illumination value may correspond to the illumination value L discussed above.

As further shown in FIG. 7A, at operation S713 the process 700A may include providing the first RGB image and the first illumination value as input to a spectral reconstruction model to obtain a first hyperspectral image. In embodiments, the spectral reconstruction model may correspond to the spectral reconstruction model 135 discussed above. In embodiments, the first hyperspectral image may correspond to the first hyperspectral image Y discussed above.

As further shown in FIG. 7A, at operation S714 the process 700A may include obtaining a first patch corresponding to the object from the first hyperspectral image.

As further shown in FIG. 7A, at operation S715 the process 700A may include calculating a supervised loss based on a comparison between a first spectral value corresponding to the first patch and a ground truth spectral value determined based on the predetermined reflectance value and the first illumination. In embodiments, the supervised loss may correspond to the supervised loss [symbol] ₛᵤₚ discussed above.

As further shown in FIG. 7A, at operation S716 the process 700A may include training the spectral reconstruction model by modifying at least one parameter of the spectral reconstruction model based on the supervised loss to obtain a trained spectral reconstruction model.

As further shown in FIG. 7A, at operation S717 the process 700A may include obtaining an input RGB image, and at operation S718 the process 700A may include providing the input RGB image to the trained spectral reconstruction model to obtain an output hyperspectral image corresponding to the input RGB image. Accordingly, after the training of the spectral reconstruction model is completed and the trained spectral reconstruction model is obtained, the trained spectral reconstruction model may be used to generate hyperspectral images based on RGB images and.

In embodiments, the scene may further include a second object, and the second object may correspond to an unknown reflectance value.

In embodiments, the first RGB image may include a red color channel, a green color channel, and a blue color channel, and the first hyperspectral image may include a plurality of color channels different from the red color channel, the green color channel, and the blue color channel.

In embodiments, the first RGB image may be included in a plurality of first RGB images, the first illumination value is included in a plurality of first illumination values corresponding to the plurality of first RGB images, the plurality of first RGB images and the plurality of first illumination values are included in a training dataset, and the spectral reconstruction model may be further trained based on the training dataset to obtain the trained spectral reconstruction model.

In embodiments the first RGB image may be captured using an RGB camera (e.g., the camera 120), and the first illumination may be measured using a spectral photometer (e.g., the spectral photometer 125).

FIG. 7B is a flowchart of an example process for training a spectral reconstruction model, according to embodiments. In some implementations, one or more process blocks of FIG. 7B may be performed by any of the elements discussed above, for example one or more of the image processing system 100, the camera 120, the spectral photometer 125, the training module 130, the spectral reconstruction model 135, and any of the components included therein. For example, one or more process blocks of FIG. 7B may be performed by the self-supervised training module 132.

As shown in FIG. 7B, at operation S721 the process 700B may include obtaining a reconstructed first RGB image based on the first hyperspectral image using a filter response of the RGB camera.

As further shown in FIG. 7B, at operation S722 the process 700B may include calculating a self-supervised loss based on a comparison between the first RGB image and the reconstructed first RGB image. In embodiments, the self-supervised loss may correspond to the self-supervised loss [symbol] _{self} discussed above.

As further shown in FIG. 7B, at operation S722 the process 700B may include training the spectral reconstruction model by modifying at least one parameter of the spectral reconstruction model based on the self-supervised loss to obtain the trained spectral reconstruction model.

FIG. 7C is a flowchart of an example process for training a spectral reconstruction model, according to embodiments. In some implementations, one or more process blocks of FIG. 7C may be performed by any of the elements discussed above, for example one or more of the image processing system 100, the camera 120, the spectral photometer 125, the training module 130, the spectral reconstruction model 135, and any of the components included therein. For example, one or more process blocks of FIG. 7C may be performed by the reillumination consistency module 133.

As shown in FIG. 7C, at operation S731 the process 700C may include obtaining a second RGB image of the scene including the object. In embodiments, the second RGB image may correspond to the second RGB image I₂ discussed above.

As further shown in FIG. 7C, at operation S732 the process 700C may include obtaining a second illumination value corresponding to the second RGB image. In embodiments, the second illumination value may represent a second illumination of the scene when the second RGB image is captured, and the second illumination may be different from the first illumination. In embodiments, the second illumination value may correspond to the second illumination value L₂ discussed above.

As further shown in FIG. 7C, at operation S733 the process 700C may include providing the second RGB image and the second illumination value as input to the spectral reconstruction model to obtain a second hyperspectral image. In embodiments, the second hyperspectral image may correspond to the second hyperspectral image Y₂ discussed above.

As further shown in FIG. 7C, at operation S734 the process 700C may include obtaining a reilluminated first hyperspectral image by performing reillumination on the first hyperspectral image based on the second illumination value.

As further shown in FIG. 7C, at operation S735 the process 700C may include calculating a reillumination consistency loss based on a comparison between the second hyperspectral image and the reilluminated first hyperspectral image. In embodiments, the reillumination consistency loss may correspond to the reillumination consistency loss [symbol] ᵣₑᵢₗₗᵤₘᵢₙₐₜᵢₒₙ discussed above.

As further shown in FIG. 7C, at operation S736 the process 700C may include training the spectral reconstruction model by modifying at least one parameter of the spectral reconstruction model based on the reillumination consistency loss to obtain the trained spectral reconstruction model.

Although FIGS. 7A-7C show example blocks of processes 700A, 700B, and 700C in some implementations, the processes 700A, 700B, and 700C may include additional blocks, fewer blocks, different blocks, or differently arranged blocks than those depicted in processes 700A, 700B, and 700C. Additionally, or alternatively, two or more of the blocks of the processes 700A, 700B, and 700C may be arranged or combined in any order, or performed in parallel.

Accordingly, embodiments may provide a process for generating a training dataset that may be used to train a hyperspectral image model, and a process for training the hyperspectral image model using the dataset. Embodiments may utilize images which include regions (e.g., color charts) for which reflectance values are known under controlled, measured illuminations. Embodiments may provide an artificial intelligence model (e.g., a deep learning model) that may be trained using a customized loss function tailored for this task, which may allow for more accurate spectral predictions in real-world scenarios. Embodiments may utilize novel metrics for assessing spectral reconstruction accuracy, focusing on signals with known ground truth reflectance values (e.g., image patches corresponding to the regions for which reflectance values are known), while ensuring the plausibility of spectral outputs in areas without ground truth data.

For example, embodiments may provide a process for leveraging real-world RGB data in the training and evaluation of spectral reconstruction techniques. This may allow for simplified data collection, and may mitigate problems that may be caused by a domain shift between real RGB images and synthetically-generated RGB data obtained based on HS images. Embodiments may provide a novel spectral reconstruction method for generating output hyperspectral images based on input RGB images. Further, embodiments may leverage mixed supervision techniques and regularizations that enable training of spectral reconstruction models with minimal pixel-by-pixel supervision.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

The various operations of methods described above may be performed by any suitable means capable of performing the operations, such as various hardware and/or software component(s), circuits, and/or module(s).

The software may include an ordered listing of executable instructions for implementing logical functions, and can be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The foregoing is illustrative of certain embodiments and is not to be construed as limiting thereof. Although a few embodiments have been described, those skilled in the art will readily appreciate that many modifications are possible in the embodiments without materially departing from the present scope.

What is claimed is:

1. An electronic device for training a spectral reconstruction model, the electronic device comprising:
a red-green-blue (RGB) camera configured to capture RGB images;
a spectral photometer configured to measure illuminations to obtain illumination values;
at least one processor; and
memory storing one or more instructions which, when executed by the at least one processor, cause the electronic device to:
obtain, using the RGB camera, a first red-green-blue (RGB) image of a scene comprising an object, wherein the object corresponds to a predetermined reflectance value,
obtain a first illumination value corresponding to the first RGB image by measuring, using the spectral photometer, a first illumination of the scene when the first RGB image is captured,
provide the first RGB image and the first illumination value as input to the spectral reconstruction model to obtain a first hyperspectral image,
obtain a first patch corresponding to the object from the first hyperspectral image,
calculate a supervised loss based on a comparison between a first spectral value corresponding to the first patch and a ground truth spectral value determined based on the predetermined reflectance value and the first illumination, and
train the spectral reconstruction model by modifying at least one parameter of the spectral reconstruction model based on the supervised loss to obtain a trained spectral reconstruction model.

2. The electronic device of claim 1, wherein the scene further comprises a second object, and
wherein the second object corresponds to an unknown reflectance value.

3. The electronic device of claim 1, wherein the instructions, when executed by the at least one processor, further cause the electronic device to:
obtain an input RGB image and a corresponding input illumination value; and
provide the input RGB image and the corresponding input illumination value as input to the trained spectral reconstruction model to obtain an output hyperspectral image corresponding to the input RGB image.

4. The electronic device of claim 1, wherein the first RGB image comprises a red color channel, a green color channel, and a blue color channel, and
wherein the first hyperspectral image comprises a plurality of color channels different from the red color channel, the green color channel, and the blue color channel.

5. The electronic device of claim 1, wherein the first RGB image is included in a plurality of first RGB images,
wherein the first illumination value is included in a plurality of first illumination values corresponding to the plurality of first RGB images,
wherein the plurality of first RGB images and the plurality of first illumination values are included in a training dataset, and
wherein the spectral reconstruction model is further trained based on the training dataset to obtain the trained spectral reconstruction model.

6. The electronic device of claim 1, wherein the instructions, when executed by the at least one processor, further cause the electronic device to:
obtain a reconstructed first RGB image based on the first hyperspectral image using a filter response of the RGB camera; and
calculate an RGB consistency loss based on a comparison between the first RGB image and the reconstructed first RGB image,
wherein the spectral reconstruction model is further trained based on the RGB consistency loss to obtain the trained spectral reconstruction model.

7. The electronic device of claim 1, wherein the instructions, when executed by the at least one processor, further cause the electronic device to:
obtain a second RGB image of the scene including the object;
obtain a second illumination value corresponding to the second RGB image by measuring, using the spectral photometer, a second illumination of the scene when the second RGB image is captured, wherein the second illumination is different from the first illumination;
provide the second RGB image and the second illumination value as input to the spectral reconstruction model to obtain a second hyperspectral image;
obtain a reilluminated first hyperspectral image by performing reillumination on the first hyperspectral image based on the second illumination value; and
calculate a reillumination consistency loss based on a comparison between the second hyperspectral image and the reilluminated first hyperspectral image,
wherein the spectral reconstruction model is further trained based on the reillumination consistency loss to obtain the trained spectral reconstruction model.

8. A method for training a spectral reconstruction model, the method comprising:
obtaining a first red-green-blue (RGB) image of a scene comprising an object, wherein the object corresponds to a predetermined reflectance value;
obtaining a first illumination value corresponding to the first RGB image, wherein the first illumination value represents a first illumination of the scene when the first RGB image is captured;
providing the first RGB image and the first illumination value as input to the spectral reconstruction model to obtain a first hyperspectral image;
obtaining a first patch corresponding to the object from the first hyperspectral image;
calculating a supervised loss based on a comparison between a first spectral value corresponding to the first patch and a ground truth spectral value determined based on the predetermined reflectance value and the first illumination; and
training the spectral reconstruction model by modifying at least one parameter of the spectral reconstruction model based on the supervised loss to obtain a trained spectral reconstruction model.

9. The method of claim 8, wherein the scene further comprises a second object, and
wherein the second object corresponds to an unknown reflectance value.

10. The method of claim 8, further comprising:
obtaining an input RGB image and a corresponding input illumination value; and
providing the input RGB image and the corresponding input illumination value as input to the trained spectral reconstruction model to obtain an output hyperspectral image corresponding to the input RGB image.

11. The method of claim 8, wherein the first RGB image comprises a red color channel, a green color channel, and a blue color channel, and
wherein the first hyperspectral image comprises a plurality of color channels different from the red color channel, the green color channel, and the blue color channel.

12. The method of claim 8, wherein the first RGB image is included in a plurality of first RGB images,
wherein the first illumination value is included in a plurality of first illumination values corresponding to the plurality of first RGB images,
wherein the plurality of first RGB images and the plurality of first illumination values are included in a training dataset, and
wherein the spectral reconstruction model is further trained based on the training dataset to obtain the trained spectral reconstruction model.

13. The method of claim 8, wherein the first RGB image is captured using an RGB camera, and
wherein the first illumination is measured using a spectral photometer.

14. The method of claim 13, further comprising:
obtaining a reconstructed first RGB image based on the first hyperspectral image using a filter response of the RGB camera; and
calculating an RGB consistency loss based on a comparison between the first RGB image and the reconstructed first RGB image,
wherein the spectral reconstruction model is further trained based on the RGB consistency loss to obtain the trained spectral reconstruction model.

15. The method of claim 8, further comprising:
obtaining a second RGB image of the scene including the object;
obtaining a second illumination value corresponding to the second RGB image, wherein the second illumination value represents a second illumination of the scene when the second RGB image is captured, and wherein the second illumination is different from the first illumination;
providing the second RGB image and the second illumination value as input to the spectral reconstruction model to obtain a second hyperspectral image;
obtaining a reilluminated first hyperspectral image by performing reillumination on the first hyperspectral image based on the second illumination value; and
calculating a reillumination consistency loss based on a comparison between the second hyperspectral image and the reilluminated first hyperspectral image,
wherein the spectral reconstruction model is further trained based on the reillumination consistency loss to obtain the trained spectral reconstruction model.

16. An electronic device for training a spectral reconstruction model, the electronic device comprising:
at least one processor; and
memory storing one or more instructions which, when executed by the at least one processor, cause the electronic device to:
obtain a first image corresponding to a first spectral space, wherein the first image comprises a first patch associated with a predetermined reflectance value,
obtain a first illumination value corresponding to the first image,
determine a ground truth spectral value based on the predetermined reflectance value and the first illumination value,
provide the first image and the first illumination value as input to the spectral reconstruction model to obtain a second image corresponding to second spectral space, wherein a dimension of the second spectral space is higher than a dimension of the first spectral space, and wherein the second image comprises a second patch corresponding to the first patch,
calculate a supervised loss based on a comparison between the ground truth spectral value and a spectral value corresponding to the second patch, and
train the spectral reconstruction model by modifying at least one parameter of the spectral reconstruction model based on the supervised loss to obtain a trained spectral reconstruction model.

17. The electronic device of claim 16, wherein the first spectral space corresponds to a spectrum of visible light.

18. The electronic device of claim 16, wherein the instructions, when executed by the at least one processor, further cause the electronic device to:
obtain an input image corresponding to the first spectral space and a corresponding input illumination value; and
provide the input image and the corresponding input illumination value as input to the trained spectral reconstruction model to obtain an output image corresponding to the second spectral space.

19. The electronic device of claim 16, wherein the first patch corresponds to a first object included in the first image,
wherein the first image further comprises an additional patch corresponding to an additional object included in the first image, and
wherein the additional patch corresponds to an unknown reflectance value.

20. The electronic device of claim 16, wherein the spectral reconstruction model is further trained based on at least one auxiliary loss, and
wherein the at least one auxiliary loss is calculated for each pixel included in the first image and the second image.
